(19) United States
(12) Patent Application Publication
(10) Pub. No.: US 2024/0304969 A1
(43) Pub. Date: Sep. 12, 2024

(54) DIELECTRICALLY LOADED FILTER WITH INCREASED POWER LOAD HANDLING

(71) Applicant: CACI, INC.- FEDERAL, Reston, VA (US)

(72) Inventors: Howell Hugh CHILES, Albuquerque, NM (US); Mark Douglas Brueggemann, Albuquerque, NM (US); Julian Jose Lucero, Albuquerque, NM (US)

(21) Appl. No.: 18/229,212

(22) Filed: Aug. 2, 2023

Related U.S. Application Data
(60) Provisional application No. 63/450,108, filed on Mar. 6, 2023.

(51) Int. Cl. H01P 1/20

(52) U.S. Cl. CPC H01P 1/2002

(57) ABSTRACT

Dielectrically loaded filters useful for communication systems such as 5G systems can include a block of dielectric material having a top surface, bottom surface, and side surfaces. The bottom and side surfaces of such a block include an electrically conductive material thereon and the top surface includes metallized and unmetallized areas thereon. The metallized areas can include a plurality of conductive pads electrically connected to a plurality of through-holes. The dielectrically loaded filter further includes a coating of a parylene polymer on at least the metallized areas of the top surface of the block. Such parylene coated dielectrically loaded filters advantageously have higher power handling relative to the same filter but without the parylene coating.

### CROSS-REFERENCE TO RELATED APPLICATION

This application claims the benefit of U.S. Provisional Application No. 63/450,108, filed Mar. 6, 2023, the entire disclosure of which is hereby incorporated by reference herein.

### TECHNICAL FIELD

The present disclosure relates to dielectrically loaded filters for radio and microwave systems and more particularly to ceramic filters configured for increased power handling.

### BACKGROUND

Many communication systems require defined bandwidths to ensure transmission of signals passing therethrough. Examples of communication systems include mobile communication systems that support high data rate services, such as mobile internet, cellular phones, broadband wireless access systems, and intelligent transport systems, among many others. These types of communication systems typically need filters to eliminate interference between adjacent bands. Ceramic transmission line filters are commonly used in communication systems due to their relatively low loss and relatively small size. For instance, ceramic transmission line filters are commonly used in radio equipment to reduce interference.

Such ceramic filters include multiple resonators which, when tuned properly, can operate in concert to achieve a desired filter performance. However, filters are generally limited by the amount of power that can be applied to the filter before arcing occurs. Arcing can damage equipment, materials, and processes. To avoid arcing at high power, filters can be designed with sufficient separations between conductive elements to prevent arcing when the filter is operated at high power levels. Such designs, however, render the filters relatively larger and heavier which are disadvantages for using such filters in portable or mobile communication systems. Other ways to prevent arcing includes enclosing the filter in a controlled environment including a filler gas.

However, a continuing need exists to provide dielectrically loaded filters for radio frequency or microwave frequency communication that are smaller, lighter and/or can handle high power operations.

### SUMMARY OF THE DISCLOSURE

An advantage of the present disclosure is a dielectrically loaded filter, e.g., a ceramic filter, with a parylene coating on at least metallized areas of a high voltage surface (top surface) of the filter. Such filters significantly improve the size, weight and power performance of a dielectrically loaded filter. Such filters can be used in communication systems with higher power or at a smaller size for the same power level.

These and other advantages are satisfied, at least in part, by a dielectrically loaded filter, e.g., a ceramic filter, comprising a block of dielectric material defined by a top surface, bottom surface, and side surfaces wherein the bottom and side surfaces include an electrically conductive material thereon; and the top surface includes metallized and unmetallized areas thereon. The filter further includes a parylene coating on at least the metallized areas and practically the unmetallized areas of the top surface of the block. The metalized areas can include and an input electrode and an output electrode and a plurality of conductive pads electrically connected to a plurality of through-holes that extend from the top surface of the block to the bottom surface of the block, wherein each conductive pad is electrically connected to a metallized interior wall of each through-hole. Advantageously, the parylene coated filter according to aspects of the present disclosure can have a peak power input, without arcing, that is at least 50% greater compared to a non-coated dielectrically loaded filter. That is, in some aspects, the dielectrically loaded filter has a peak power input in which arcing occurs between metallized areas on the top surface of the block that is at least 50% greater relative to a non-coated dielectrically loaded filter that is identical to the dielectrically loaded filter except the non-coated dielectrically loaded filter does not have the parylene coating.

One or more implementations of the dielectrically loaded filter can include one or more of the following features individually or combined. For example, the dielectrically loaded filter can further include one or more walls extending upwardly from the top surface, each wall having an inner surface and an outer surface. In some examples, at least a portion of the inner surface of the one or more walls includes the parylene coating. In further examples, the parylene coating can include parylene-N. In other examples, the dielectric block can include a ceramic, such as a ceramic comprised of BaO, TiO₂, ZrO₂, etc., or combinations thereof. In still further examples, the dielectric block has an input peak power of over 500 W at 240 torr (240 mmHg) and such a filter can have dimensions of no greater than about 5.1 inches in length, about 1.4 inches in width and about 0.4 inches in thickness, for example. Dielectrically loaded filters of the present disclosure can be configured to be in electrical contact with a printed circuit board and/or configured a duplex filter.

Other aspects of the present disclosure include a communication system that comprises a dielectrically loaded filter according to the present disclosure and processes of either or both receiving or transmitting a radio frequency signal through the dielectrically loaded filter in a communication system. The dielectrically loaded filter can be mounted and in electrical contact with a printed circuit board and included in the circuitry of a communication system.

Additional advantages of the present disclosure will become readily apparent to those skilled in this art from the following detailed description, wherein only certain embodiment are shown and described, simply by way of illustration of carrying out certain subject matter. As will be realized, the invention is capable of other and different embodiments, and its several details are capable of modifications in various respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 illustrates a perspective view of a dielectrically loaded filter according to aspects of the present disclosure.

FIG. 2 illustrates the dielectrically loaded filter of FIG. 1 mounted on a printed circuit board in accordance with aspects of the present disclosure.

FIG. 3A and FIG. 3B illustrate a duplex dielectrically loaded filter according to aspects of the present disclosure. FIG. 3A shows a schematic view and FIG. 3B shows a perspective view of the filter.

FIG. 4 is a chart comparing insertion loss shift for ceramic filter prior to coating and after forming a parylene N coating on the high voltage surface (top surface) of the filter.

FIG. 5 is a chart comparing return loss shift for ceramic filter prior to coating and after forming a parylene N coating on the high voltage surface (top surface) of the filter.

### DETAILED DESCRIPTION OF THE DISCLOSURE

Dielectric transmission line filters, e.g., ceramic filters, are particularly beneficial transmission line filters due to their small size and weight. Ceramic transmission line filters can include a block of ceramic having high permittivity and low loss characteristics, with a design to achieve particular attenuation and propagation at specific frequencies. Such filters include a high voltage surface that includes metallized and unmetallized areas thereon, e.g., metallized areas surrounded by the unmetallized dielectric areas. The metalized areas include at a minimum a plurality of conductive pads electrically connected to a plurality of through-holes that extend from the top surface of the block to the bottom surface of the block. Each conductive pad is electrically connected to a metallized interior wall of each through-hole. The metallized areas on the top surface of the dielectrically loaded filter can also include an input electrode and an output electrode. However, arcing between metallized areas on the top surface of the dielectrically loaded filter imposes a minimum size and weight with a given filter technology for RF products that use them.

It was discovered that the power handling capability of a given dielectrically loaded filter can be increased significantly, or alternatively the size of a given dielectrically loaded filter could be significantly reduced while meeting the same power handling specification of a larger filter, by applying a parylene coating on metallized and unmetallized areas on the high voltage surface of the dielectrically loaded filter. That is, the peak power input of a dielectrically loaded filter, e.g., a ceramic filter, with a parylene coating on metallized and unmetallized areas on a high voltage surface (top surface) thereof can be increased by at least 50%, such as by at least 75% and by at least 100%, without arcing compared to the same filter but without the parylene coating. It is believed that a parylene coating on at least the metallized areas, or on at least on the outer edges of the metallized areas, on the high voltage surface of the dielectrically loaded filter allows for an increased applied voltage between metallized areas without arcing. While not needed to practice aspects of the present disclosure, additionally having a parylene coating between such metallized areas further facilitates reduced arcing between metallized areas.

Alternatively, the overall size (e.g., reduced volume or weight) of a dielectrically loaded filter, e.g., a ceramic filter, with a parylene coating on at least metallized areas on a high voltage surface (top surface) thereof can be at least 50% less, such as by at least 75% and 100% less, compared to a dielectrically loaded filter without the parylene coating but having the same peak power specification. In this manner the size, weight and power of a given dielectrically loaded filter can be significantly improved. That is, a smaller sized filter having a parylene on a high voltage surface thereof can perform at the same power level as a physically larger filter. Advantageously, a parylene coating enables the design of dielectrically loaded filters with reduced size, volume and weight for a given input or peak power value thereby allowing communication systems that include such filters with reduced size and weight, which is of particular benefit for systems that employ a large number of filters, such as 5G systems.

In one aspect of the present disclosure, a dielectrically loaded filter can include a dielectric block, e.g., a ceramic block, having an input peak power of over 500 W at 240 torr (240 mmHg) and dimensions of no greater than about 5.1 inches in length, about 1.4 inches in width and about 0.4 inches in thickness.

As used herein, a parylene coating refers to a coating composed of one or more polymers prepared from substituted or unsubstituted p-xylylene. Parylenes have as a repeating structure: -(para-CX₂-C₆HₐY₍₄₊ₐ₎—CX₂)ₙ—. In this structure, X can be the same or different and can be hydrogen or halogen (e.g., chlorine, bromine, iodine and/or fluorine), n can be any integer that forms a stable coating such as between 10 and 50,000 (e.g., 100 to 20,000), a is an integer of between 0 and 4 and Y is an aromatic substituent that can be the same or different and can be any inert organic or inorganic group such as amino, aryl, alkyl, alkenyl, alkoxy, hydroxyl, nitro, halogen, e.g., chlorine, bromine, iodine and/or fluorine.

Preferably, the parylene coating does not significantly interfere with the function of the dielectrically loaded filter such as significantly interfering with radio or microwave signals. Parylene-N (poly(para-xylylene)) in which X is hydrogen and a is 4 in the formula -(para-CX₂-C₆HₐY₍₄₋ₐ₎—CX₂)ₙ— is such a parylene that can be used as a coating on dielectrically loaded filters without significantly interfering with the function of the filter. Other parylene polymers include poly(2-chloro-para-xylylene) (“parylene C”, wherein X is hydrogen, a is 3 and Y is chlorine), poly(2,5-dichloro-para-xylylene) (“parylene D”, wherein X is hydrogen, a is 2 and Y is chlorine), PARYLENE HT, available from Specialty Coating Systems of Indiana, wherein X is fluorine and a is 4 and parylene AF-4, with the four hydrogen atoms on the aliphatic chain replaced by fluorine atoms.

Parylene can be coated on a dielectrically loaded filter by placing the filter to be coated within a vacuum coating chamber of a coating system. Parylene monomer such as a solid parylene dimer is also placed inside the systems. The system heats the parylene monomer and causes polymerization of the monomer onto exposed surfaces of the filter. The deposition/polymerization process preferably creates a thin and conformal coating that is more or less uniform on exposed regions of the filter. The thickness of the coating is determined by certain processing conditions such as temperature, time and pressure which can be adjusted to provide a particular thickness of a conformal parylene coating. Coating thicknesses can range from about 0.1 mils (about 2.5 microns) to about 10 mils (254 microns) such as from about 0.5 mils (13 microns) to about 5 mils (127 microns), etc.

The filter can be masked prior to the coating process to avoid coating parylene on certain regions of the filter. In general, masking involves applying a physical barrier to selectively keep areas free of parylene coating. After the filter is coated, the masking is removed leaving the masked regions free of the coating.

The parylene coating can act as a barrier material and its composition and thickness is selected to have a minimal effect on the RF performance of the filter but sufficient to prevent arcing between electrical elements on the high voltage surface of the dielectrically loaded filter while the filter is electrically active. By reducing arcing in a particular filter configuration, the power can be increased in a filter that would ordinarily arc and fail. Alternatively, a dielectrically loaded filter with a parylene coating enables the design of a smaller filter with the same power capability compared to a much larger part thereby greatly reducing the size of the filter and systems which uses them.

Another aspect of the present disclosure includes a method of coating a dielectrically loaded filter. The method includes vapor depositing a parylene coating on at least the metallized areas of a high voltage surface (top surface) of the dielectrically loaded filter. In practice, is may be convenient to vapor deposit a parylene coating on the metallized and unmetallized areas of the top surface of the dielectrically loaded filter, e.g. on the top surface of a dielectric block such as a ceramic block.

The coated metalized areas can include at a minimum a plurality of conductive pads electrically connected to a plurality of through-holes that extend from the top surface of the block to the bottom surface of the block. Each coated conductive pad is electrically connected to a metallized interior wall of each through-hole. The coated metallized areas on the top surface of the dielectrically loaded filter can also include coated input and an output electrodes.

The method can further include vapor depositing a parylene coating on an inner wall extending upwardly from the top surface of the dielectrically loaded filter, preferably coating the inner wall near the top surface. In an aspect of the present disclosure, a parylene coating is not formed on an upper portion of the wall or on the rim or on electrical elements on the top surface of the dielectrically loaded filter configured to electrically connect the filter to another component such as a printed circuit board.

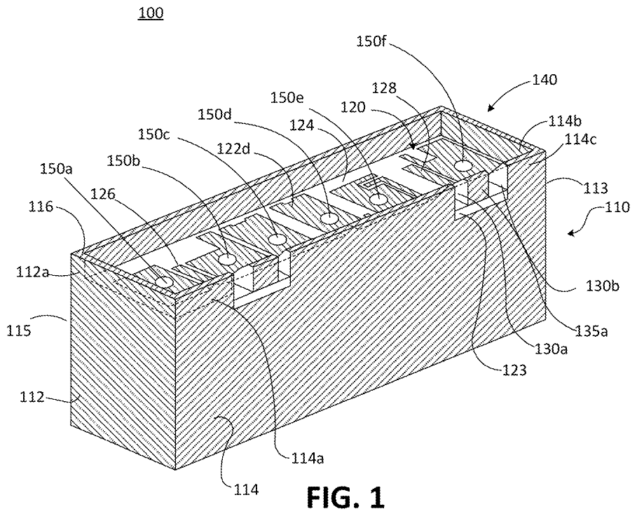

The following figures illustrate various aspects of the present disclosure. For example, FIG. 1 illustrates a radio frequency (RF) filter 100 according to an aspect of the present disclosure. As illustrated, filter 100 has an elongate, parallelepiped or box-shape. However, the filter can be in any shape and can include additional features such as grooves or slots on side, top and/or bottom surfaces. Filter 100 includes block 110 having a top surface 120 and bottom surface (not shown) and four side surfaces or faces, which include minor side surfaces (112, 113) and major side surfaces (114, 115). Block 110 can be composed of a dielectric material having a desired dielectric constant. For example, block can be constructed of a suitable dielectric material that has low loss, a high dielectric constant, and a low temperature coefficient such as a ceramic dielectric material, e.g., a ceramic comprised of BaO, TiO₂, ZrO₂, etc., and combinations thereof.

Although not necessary for practicing certain aspects of the present disclosure, filter 100 can also include four generally planar walls (112a and 114a are representative) that extend upwardly from top surface 120. Each wall has an inner and outer surface and together the walls form a rim or roof 116. As a representative example, wall 114a extends coextensively from side surface 114 and wall 114a has an inner surface 114b and outer surface 114c. The four generally planar walls that extend upwardly from top surface 120 together with top surface 120 define a cavity 140. Although not needed to practice aspects of the present disclosure, the filter of FIG. 1 includes slots. As further illustrated in FIG. 1, wall 114a can include plural, spaced-apart slots (e.g., 130a, 130b) that extend through planar wall 114a from the inner to the outer surface of wall 114a. The slots can have similar or different widths. Further, two spaced-apart slots in wall 114a can define a post (135a) and a plural number of post can be formed, each having similar or different widths and lengths.

Top surface 120 of block 110 includes a pattern thereon with metalized and unmetallized areas in which unmetallized areas generally surround certain metalized areas. The metallized areas include a plurality of conductive pads electrically isolated from one another by unmetallized dielectric areas. The plurality of conductive pads are electrically connected to a plurality of through-holes that extend from the top surface of the block to the bottom surface of the block. Each conductive pad is electrically connected to a metallized interior wall of each through-hole. The metallized areas of the top surface of the dielectrically loaded filter further include electrodes that serves as input and output connections to the dielectrically loaded filter. Such a configuration results in metallized areas spaced apart from one another and capacitively coupled. The amount of capacitive coupling is roughly related to the size of the metallization areas and the separation distance between adjacent metallized areas as well as the overall core configuration and the dielectric constant of the dielectric material. Similarly, the metalized and unmetallized pattern on surface 120 also creates inductive coupling between the metallized areas. The metallized and unmetallized areas on the top surface of block 110 defines a high voltage surface of the block.

As illustrated in FIG. 1, block 110 includes a plurality of through-holes, each of which extend from the top surface to the bottom surface. The interior wall defining the through-hole is coated or plated with an electrically conductive material (e.g., a metal such as copper, silver, nickel, etc., metal alloy, etc.). As shown in FIG. 1, block 110 includes through-holes 150a, 150b, 150c, 150d, 150e and 150f, each of which extend from top surface 120 to the bottom surface (not shown) of block 110 and have an interior wall defining the through-hole, which is metallized. The through-holes can be shaped and spaced apart from each other and spaced-apart from the side surfaces of the block for certain filter response characteristics. As illustrated in FIG. 1, through-holes 150a-150f are aligned in a spaced-apart, co-linear relationship and are also approximately equidistant from the side surfaces 114 and 115.

As illustrated in FIG. 1, a portion of metallized areas form resonator pads or plates 122a, 122b, 122c, 122d, 122e and 122f (122d is representative as illustrated by the reference indicator in the drawing). Each resonator pad can at least partially surround a through-hole 150 opening located on top surface 120 (150d is representative as illustrated by the reference indicator in the drawing). For example, each resonator pad 122 can entirely surround a through-hole 150. As illustrated, each resonator pad 122 is electrically connected and contiguous with the metallized interior wall of each through-hole 150. As such, each through-hole and electrically connected pad form a resonator. Resonator pads 122a-f (122d is representative as illustrated by the reference indicator in the drawing) are shaped to have predetermined capacitive couplings to adjacent resonators and other areas of the surface-layer metallization. An unmetallized area or pattern 124 covers portions of top surface 120. Unmetallized areas 124 surround all of the metallized resonator pads 122a-f.

Top surface 120 of block 110 additionally includes a pair of isolated conductive metallized areas 126, 128 for input and output connections to filter 100. An input connection area or electrode 126 and an output connection area or electrode 128 are defined on top surface 120 and extend onto a portion of rim 116 and planar wall 114a and side surface 114. The electrodes can serve as surface mounting conductive connection points such as pads or contacts. Electrodes 126 and 128 are located adjacent and parallel to side surfaces 112. Each electrode is located between two resonator pads, e.g., electrode 126 is between resonator pads 122a and 122b and electrode 128 is between resonator pad 122e and 122f. Electrodes 126 and 128 are surrounded on all sides by unmetallized areas 124. Such electrodes are capacitively coupled to the resonators, i.e., each through-hole and electrically connected pad form a resonator.

Unmetallized area 124 extends on the top surface 120 and on side surfaces of post 135a (post 135a is representative as illustrated by the reference indicator in the drawings). In an aspect of the present disclosure, unmetallized area 124 can also extend onto a portion 123 of side surface 114 located below the post 135a. Portion 123 can also extend below the slots 130a and 130b. These unmetallized areas are co-extensive or joined or coupled with each other in an electrically non-conducting relationship.

The bottom surface 115, side surfaces 112, 113, 114 and 115 can include a layer of conductive material, e.g., a metal or metal alloy, which can be the same conductive material or different conductive material on different side and bottom surfaces. Portions of the inner and outer surfaces of planar walls (112a and 114a are representative) that extend upwardly from top surface 120 can also have a metallized layer.

In accordance with aspects of the present disclosure, the high voltage surface of the dielectrically loaded filter, e.g., top surface 120, has a coating of parylene polymer thereon. In particular, the metallized areas, including the metallized pads and metallized electrodes, and optionally the unmetallized areas on the top surface 120 of block 110 have a parylene coating thereon. Optionally, the interior metallized walls of one or more through-hole can include the parylene coating and the inner surface of one or more walls extending from the top surface of the dielectrically loaded filter can also have the parylene coating. Although it is not necessary to practice aspects of the present disclosure, it may be convenient to also form a parylene coating on the exterior surfaces of the walls extending from top surface 120 and on the sides (112, 113, 114, 115) and bottom of the block. However, the areas intended to be electrically or physically connected to another component, such as a circuit board, should preferably avoid having a parylene coating.

Once the dielectrically loaded filter includes a parylene coating on the top surface of the block, it can be connected to other components such as a printed circuit board and/or installed or mounted in a communication system.

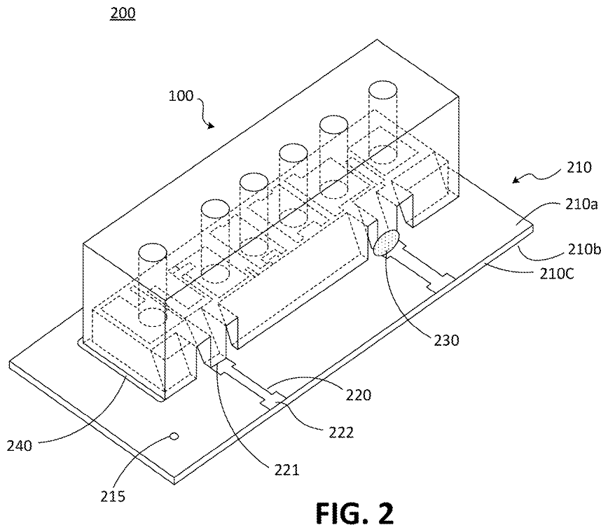

For example, FIG. 2 illustrates parylene coated dielectrically loaded filter 100 mounted on a printed circuit board. As shown, circuit board 210 is a generally planar rectangular shaped circuit board having a top or top surface 210a, bottom or bottom surface 210b and sides or side surfaces 210c. Circuit board 210 has a height of a predetermined thickness. Circuit board 210 also includes plated through-holes 215 that form an electrical connection between the top and the bottom of the circuit board 210. Several circuit lines 220 and input/output connection pads 221 can be located on top surface 210a and connected with terminals 222. Circuit lines 220, connecting pads 221 to terminals 222 can be formed, for example, from a metal such as copper. Terminals 222 connect the filter 100 with an external electrical circuit (not shown).

A post of the filter 100 can be attached to the printed circuit board (PCB) 200 at the connection pad(s) 221 by solder or conductive epoxy 230. In an embodiment, one or both of the input 126 and output 128 electrodes of filter 100 (shown in FIG. 1) can be electrically connected to the circuit board such as with a solder or an conductive epoxy.

Circuit board 200 has a generally rectangular-shaped ground ring or line 240 disposed on the top surface 210a of the board. The line 240 can be formed around the rim of the filter to electrically ground the filter. Line 240 can be formed from a metal such as copper. Filter 100 can be positioned on the top surface of the PCB 210a such that input electrode portion 126 and output electrode portion 128 are aligned with connection pads 221. Circuit board 200 and filter 100 can be placed in a reflow oven to melt and reflow solders or cure conductive epoxy positioned on the board.

As illustrated in FIG. 2, filter 100 is mounted to the board 200 in a top side down relationship. As a result, the top surface 120 of the filter is configured opposite, parallel to, and spaced from the top surface 210a of the board. Advantageously, rim 116 of the filter is soldered to the top of the PCB. In this relationship, cavity 140 is sealed to define an enclosure defined by the top, recessed surface 120, the board surface 210a, and the walls (112a and 114a are representative) that extend upwardly from top surface 120 of the filter. It is further noted that, in this relationship, the through-holes in filter are oriented in a relationship generally normal to the board 200.

The use of filter 100 with recessed top surface pattern 120 facing and opposite the board provides improved grounding and off band signal absorption; confines the electromagnetic fields within cavity 140. The arrangement also prevents external electromagnetic fields outside of cavity 140 from causing noise and interference such that the attenuation poles and zero points of the filter are improved. The arrangement of the cavity also prevents the electromagnetic fields from interfering and coupling with other components mounted near filter 100. The technology allows the same footprint to be used across multiple frequency bands. In addition, during solder reflow, filter 100 tends to self-align with the ground ring 240 on the circuit board. The Filter exhibits improved self-alignment since the surface tension of the liquid solder during reflow is distributed equally around the rim between the ground ring and rim providing self-centering of the filter's block 110.

The use of a filter 100 defining a cavity and a recessed top surface with metallized pattern facing and opposite the board eliminates the need for a separate external metal shield or other shielding as currently used to reduce spurious electromagnetic interference incurred.

The recessed pattern creates a resonant circuit that includes a capacitance and an inductance in series connected to ground. The shape of pattern determines the overall capacitance and inductance values. The capacitance and inductance values are designed to form a resonant circuit that suppresses the frequency response at frequencies outside the passband including various harmonic frequencies at integer intervals of the passband.

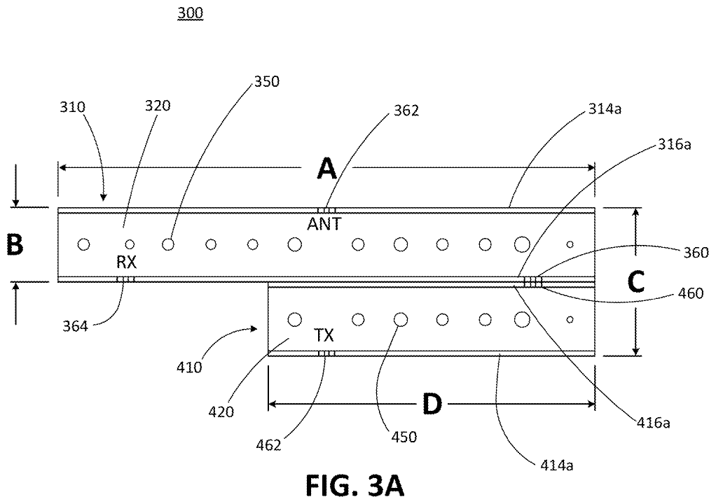

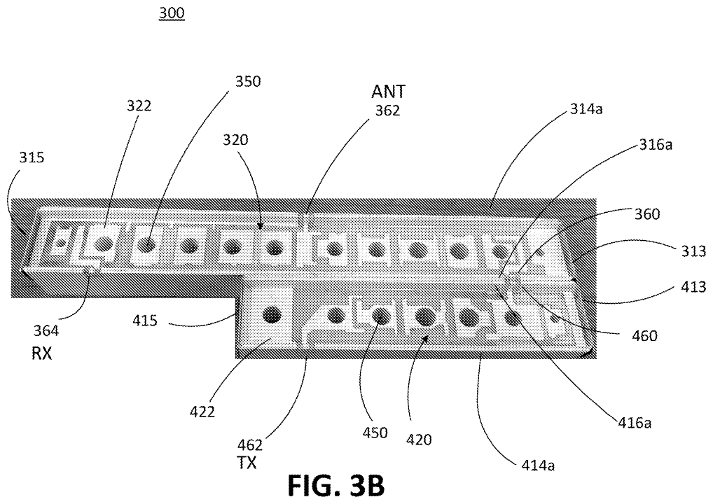

FIG. 3A and FIG. 3B illustrate a duplex filter 300 in accordance with aspects of the present disclosure. As shown, two dielectrically loaded filters, e.g. two ceramic filters, are adjoined along major side surfaces creating a duplex filter. In particular, dielectric block 310 and dielectric block 410 each have a plurality of through-holes 350 and 450, respectively, each of which extend from the top surfaces 320, 420 to the bottom surfaces of the blocks (not shown) with interior, metallized walls (not shown) and surrounded by resonator pads 322, 422, respectively. The top surfaces 320 and 420 of blocks 310 and 410 define a high voltage surface of each block and include metallized areas such as resonator pads and electrodes (not shown) surrounded by unmetallized areas. Block 310 includes walls (314a, 316a) that extend upwardly from top surface 320 and block 410 includes walls (414a, 416a) that extend upwardly from top surface 420. Each wall has an inner and outer surface. In addition, block 310 can include a metal plate on either end 313 and 315 of the block and block 410 can also include metal plates on opposite ends 413 and 415.

Block 310 additionally includes metallized areas configured to electrically connect an antenna (ANT) 362 and a receiver (RX) 364, and block 410 includes metallized areas configured to electrically connect a transmitter (TX) 462. Further, the blocks are electrically connected at metallized area 360 and 460, respectively.

For this example, block 310 can have approximate dimensions of length (A) of about 5.1 inches, width (B) of about 0.7 inches and block 410 has approximate dimensions of length (D) of about 3.1 inches and width (B) of about 0.7 inches.

In accordance with aspects of the present disclosure, the high voltage surfaces of the dielectrically loaded filter, e.g., top surfaces 320 and 420, have a coating of a parylene polymer thereon. In particular, the metallized areas, including the metallized pads and metallized electrodes, and optionally the unmetallized areas on the top surfaces 320 and 420 have a parylene coating thereon. Optionally, the inner surface of one or more walls extending from the top surface of the dielectrically loaded filter can also have a parylene coating. Although it is not necessary to practice aspects of the present disclosure, it may be convenient to also form a parylene coating on the exterior surfaces of the walls and on the sides and bottom of each block. However, areas of the filters intended to be electrically connected to an outside circuit, e.g., antenna (ANT) 362, receiver (RX) 364, transmitter (TX) 462 should be free of the parylene coating as well as areas of the filter intended to be electrically or physically connected to another component such as to a circuit board, should preferably be free of a parylene coating.

The parylene coating on the top surfaces of blocks 320 and 420 can be formed simultaneously on the blocks or on the blocks individually prior to joining the blocks to form the duplex.

Once the dielectrically loaded filters have a parylene coating on top surfaces thereof over metallized areas of the block, the duplex filter can be connected to other components such as a printed circuit board and/or installed or mounted in a communication system. Such filters of the present disclosure offer high selectivity and narrow bandwidth under high power, e.g., greater than 350 W, and at high altitude, e.g., greater than 35,000 ft.

Advantageously, a communication system including a dielectrically loaded filter of the present disclosure can receive or transmit a signal, e.g., a radio frequency signal, that allows the system to transmit at higher power levels with the same filter that was originally designed for a lower power level. This decreases the required size of the system making it lighter and smaller. For example, dielectrically loaded filters of the present disclosure can be used in various types of base stations that receive and transmit a signal, including 5G small cells. In aspects of the present disclosure, dielectrically loaded filters of the present disclosure can either or both receive or transmit a radio frequency signal through the filter in a communication system. In such a system, the filter allows certain radio frequencies to pass through the filter while rejecting other frequencies from passing through the filter. Dielectrically loaded filters of the present disclosure offer high selectivity and narrow bandwidth under high power, e.g., greater than 350 W peak power, such as greater than 500 W, 600 W peak power and at high altitude, e.g., greater than 10,000 ft, such as greater than 35,000 ft.

### EXAMPLES

The following examples are intended to further illustrate certain aspects of the subject technology and are not limiting in nature. Those skilled in the art will recognize, or be able to ascertain, using no more than routine experimentation, numerous equivalents to the specific substances and procedures described herein.

Commercially available RF ceramic filters were tested for arcing by applying certain input power and at certain reduced atmospheric pressure to simulate altitude. Filters were tested prior to and after applying a parylene-N coating to the high voltage (top) surface of the filter. The filters tested were identical except for the parylene-N coating on the coated filters.

The filter selected for testing was a 1.8 GHz duplexer having a recessed top pattern and a specification rating of 325 watts peak at 240 mmHg (389 Torr/35,000 ft) with a configuration similar to that shown in FIG. 3. Testing was on 10 samples. The filter samples, prior to the parylene coating, failed power testing at 325 watts peak and a simulated 35,000 ft. Failing here means the filters would arc between resonators along the high voltage surface each time they were subjected to the 35,000 ft and a 325 W peak power level.

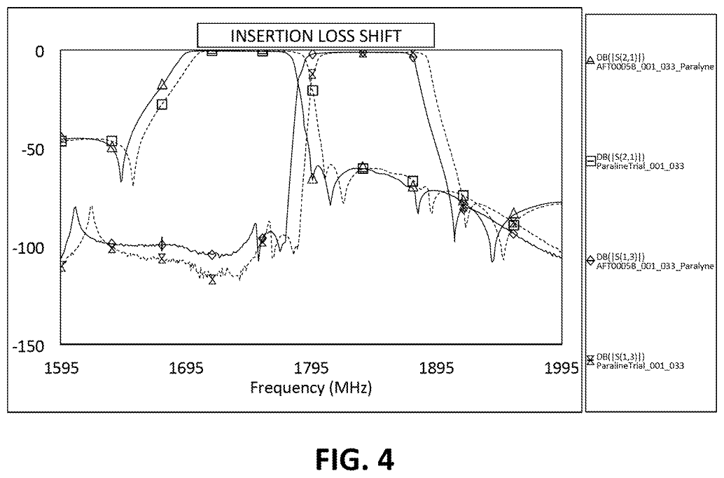

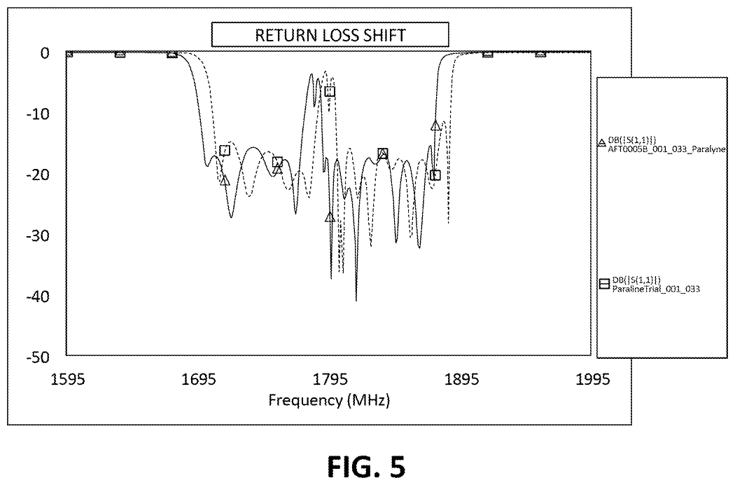

A parylene N coating was then applied on the filters that failed the power testing. The coating was formed by vapor depositing p-xylylene to form a parylene-N coating on the top surface (high voltage surface) of the filters including on metal plates, metallized through-holes and unmetallized (dielectric) areas on the top surface of the filters. The parylene-N coating was also formed on the inner walls extending from the top surface of the filter but not on the rim (roof). The rim, outer walls, bottom and side surfaces were masked-off to avoid forming the parylene-N coating thereon. Regions of the filter intended to form electrical connections to a circuit board, antenna, receiver and transmitter were also masked-off to avoid coating those regions of the filter. The formed parylene-N coating was a uniform, conformal coating over exposed regions of the filter and approximately 1.5 mils (about 38 microns) in thickness. The parylene-N coating had relatively minimal interference with an RF signal of the filter, e.g., a CoF shift of about-10 MHz. See FIGS. 4 and 5 show charts that compare insertion loss shift and return loss shift, respectively, for uncoated and coated filters.

The coated filters were then tested again for peak power failure. A first test was performed on parylene coated filters by initially applying 325 watts peak power and increasing the power in 25 W increments up to 720 watts peak. Surprisingly, no failures observed at 240 mmHg (35,000 ft). We stopped the applying power at 720 W peak because that was the limit of our equipment. The second test was a high altitude test, which subjected coated filters starting at 110 torr (45,000 ft) at 500 W peak, then jumped to 8 torr (110,000 ft) still at 500 W peak with no failure. Filters of this type have a greater propensity to failure at higher elevation due to lower electrical breakdown of the air as elevation is increased. It was surprising that none of the filters failed power testing since once a filter exhibits arcing it tends to continue to arc. However, applying a parylene coating on the previously failed filters surprisingly allowed the filters to operate at even higher peak power without failing.

It was evident from these tests that the parylene coating on metallized areas of the top surface of the filter significantly extended the power handling capacity of the filter. In fact, our testing showed that an RF ceramic filter with a parylene coating over metallized areas was capable of handling over 50% more power than the same filter without the coating.

Another coated filter was tested up to the limit of our power testing capacity of 720 W at the filter input. This translates to around 930 W of amplifier output, minus setup losses (1000 W is max). Our testing showed that an RF ceramic filter with a parylene coating on its top surface covering metallized and unmetallized areas was capable of handling greater than 100% more power than the same filter without the parylene coating.

While the filters, apparatus, systems and methods have been described in detail and with reference to specific aspects thereof, it will be apparent to one of ordinary skill in the art that various changes and modifications can be made without departing from the spirit and scope thereof. Thus, for example, those skilled in the art will recognize, or be able to ascertain, using no more than routine experimentation, numerous equivalents to the specific apparatus, systems, substances and procedures described herein. Such equivalents are considered to be within the scope of this invention, and are covered by the following claims.

What is claimed is:

1. A dielectrically loaded filter comprising:
a block of dielectric material defined by a top surface, bottom surface, and side surfaces wherein the bottom and side surfaces include an electrically conductive material thereon; and the top surface includes metallized and unmetallized areas thereon;
a parylene coating on the metallized and unmetallized areas of the top surface of the block;
wherein the metalized areas include an input electrode and an output electrode and a plurality of conductive pads electrically connected to a plurality of through-holes that extend from the top surface of the block to the bottom surface of the block, wherein each conductive pad is electrically connected to a metallized interior wall of each through-hole.

2. The dielectrically loaded filter of claim 1, wherein the dielectrically loaded filter has a peak power input in which arcing occurs between metallized areas on the top surface of the block that is at least 50% greater compared to a non-coated dielectrically loaded filter that is identical to the dielectrically loaded filter except the non-coated dielectrically loaded filter does not have the parylene coating.

3. The dielectrically loaded filter of claim 1, wherein the parylene coating comprises parylene-N.

4. The dielectrically loaded filter of claim 1, wherein the dielectric block comprises a ceramic.

5. The dielectrically loaded filter of claim 1, wherein the dielectric block has an input peak power of over 500 W at 240 torr (240 mmHg) and dimensions of no greater than about 5.1 inches in length, about 1.4 inches in width and about 0.4 inches in thickness.

6. The dielectrically loaded filter of claim 1, wherein the dielectrically loaded filter includes one or more walls extending upwardly from the top surface, each wall having an inner surface and an outer surface, and wherein at least a portion of the inner surface of the one or more walls includes the parylene coating.

7. The dielectrically loaded filter of claim 1, wherein the bottom and side surfaces of the block are substantially free of the parylene coating.

8. The dielectrically loaded filter of claim 1, wherein the dielectrically loaded filter is in electrical contact with a printed circuit board.

9. A communication system that comprises the dielectrically loaded filter of claim 1 in electrical contact with the printed circuit board.

10. A duplex filter comprising at least the dielectrically loaded filter according to claim 1.

11. A duplex filter that comprises at least two filters according to claim 1.

12. A communication system comprising:
a printed circuit board having a top surface and including input and output pads; and
a dielectrically loaded filter including:
a block of dielectric material defined by a top surface, bottom surface, and side surfaces and a wall extending upwardly from the top surface; wherein the bottom and side surfaces include an electrically conductive material thereon; the top surface includes metallized and unmetallized areas thereon, and the top surface of the block is configured opposite, parallel to, and spaced from the top surface of the board; and
a parylene coating on the metallized and unmetallized areas of the top surface of the block.

13. The communication system according to claim 12, wherein the metalized areas on the top surface of the block include and an input electrode, an output electrode and a plurality of conductive pads electrically connected to a plurality of through-holes that extend from the top surface of the block to the bottom surface of the block, wherein each conductive pad is electrically connected to a metallized interior wall of each through-hole; and
wherein the input electrode is in electrical contact with the input pad of the circuit board and the output electrode is in electrical contact with the output pad of the circuit board.

14. The communication system according to claim 12, wherein the parylene coating comprises parylene-N.

15. The communication system according to claim 12, wherein the dielectric block comprises a ceramic.

16. A process of receiving or transmitting a radio frequency signal, the process comprising either or both of receiving or transmitting a radio frequency signal through a dielectrically loaded filter in a communication system;
wherein the dielectrically loaded filter comprises a block of dielectric material defined by a top surface, bottom surface, and side surfaces; wherein the bottom and side surfaces include an electrically conductive material thereon; and the top surface includes a parylene coating on metallized and unmetallized areas on the top surface of the block.

17. The process according to claim 16, wherein the metalized areas on the top surface of the block include and an input electrode, an output electrode and a plurality of conductive pads electrically connected to a plurality of through-holes that extend from the top surface of the block to the bottom surface of the block, wherein each conductive pad is electrically connected to a metallized interior wall of each through-hole; and
wherein the input electrode is in electrical contact with the input pad of the circuit board and the output electrode is in electrical contact with the output pad of the circuit board.

18. The process according to claim 16, wherein the parylene coating comprises parylene-N.

19. The process according to claim 16, wherein the dielectric block comprises a ceramic.

20. The process according to claim 16, wherein the dielectrically loaded filter is configured to operate at 350 watts of peak power.
